(19) United States
(12) Patent Application Publication
(10) Pub. No.: US 2026/0285364 A1
(43) Pub. Date: Sep. 24, 2026

(54) METHOD OF PARALLELIZED OCCUPANCY GRID COLLISION CHECKING

(71) Applicant: Torc Robotics, Inc., Blacksburg, VA (US)

(72) Inventors: . Raghav, Quebec (CA); Savio Pereira, Austin, TX (US); Akshay Pai Raikar, Austin, TX (US); Ajay Tulsyan, Austin, TX (US)

(21) Appl. No.: 19/088,568

(22) Filed: Mar. 24, 2025

(51) Int. Cl. B60W 60/00; B60W 50/14

(52) U.S. Cl. CPC B60W 60/0011; B60W 50/14; B60W 60/0015; B60W 60/00274; B60W 2050/146; B60W 2554/4045

(57) ABSTRACT

An autonomy computing system is configured to: identify, based upon perception sensor data, a plurality of actors in an environment of an autonomous vehicle comprising the autonomy computing system; generate a respective anticipated trajectory on a canvas for each actor of the plurality of actors; generate each of a plurality of anticipated trajectories of the autonomous vehicle in a separate canvas; perform a binary AND operation between each pixel of the canvas having the respective anticipated trajectory for each actor of the plurality of actors and each pixel of a canvas having an anticipated trajectory of the plurality of anticipated trajectories of the autonomous vehicle; and based upon the performed binary AND operation, identify one or more pixels in which the anticipated trajectory of the plurality of anticipated trajectories of the autonomous vehicle having collision with at least one actor of the plurality of actors and discard the anticipated trajectory.

### TECHNICAL FIELD

The field of the disclosure relates to autonomous vehicles and, more specifically, for generating safe and comfortable trajectories for autonomous vehicles using a parallelized occupancy grid collision checking method.

### BACKGROUND OF THE INVENTION

Autonomous vehicles employ fundamental technologies such as, perception, localization, behaviors and planning, and control. Perception technologies enable an autonomous vehicle to sense and process its environment. Perception technologies process a sensed environment to identify and classify objects, or groups of objects, in the environment, for example, pedestrians, vehicles, or debris. Localization technologies determine, based on the sensed environment, for example, where in the world, or on a map, the autonomous vehicle is. Localization technologies process features in the sensed environment to correlate, or register, those features to known features on a map. Localization technologies may rely on inertial navigation system (INS) data. Behaviors and planning (or behaviors and motion planning (BMP)) technologies determine how to move through the sensed environment to reach a planned destination. Behaviors and planning technologies process data representing the sensed environment and localization or mapping data to plan maneuvers and routes to reach the planned destination for execution by a controller or a control module. Controller technologies use control theory to determine how to translate desired behaviors and trajectories into actions undertaken by the vehicle through its dynamic mechanical components. This includes steering, braking and acceleration.

The BMP technologies is a component of a Virtual Driver (VD) stack and responsible for generating safe and comfortable trajectories for the autonomous vehicle to follow. The BMP component consumes information from upstream components associated with perception, actor prediction, and mapping, and generate a trajectory information for the autonomous vehicle.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, an autonomy computing system including at least one memory configured to store machine executable instructions, and at least one processor coupled to the at least one memory and configured to execute the machine executable instructions is disclosed. The machine executable instructions configure the at least one processor to: identify, based upon perception sensor data of a plurality of perception sensors, a plurality of actors in an environment of an autonomous vehicle comprising the autonomy computing system; generate a respective anticipated trajectory on a canvas for each actor of the plurality of actors; generate a plurality of anticipated trajectories of the autonomous vehicle, wherein each anticipated trajectory of the plurality of anticipated trajectories of the autonomous vehicle is generated in a separate canvas; perform a binary AND operation between each pixel of the canvas having the respective anticipated trajectory for each actor of the plurality of actors and each pixel of a canvas having an anticipated trajectory of the plurality of anticipated trajectories of the autonomous vehicle; based upon the performed binary AND operation, identify one or more pixels in which the anticipated trajectory of the plurality of anticipated trajectories of the autonomous vehicle having collision with at least one actor of the plurality of actors; and discard the anticipated trajectory of the plurality of anticipated trajectories of the autonomous vehicle.

In another aspect, a computer-implemented method is disclosed. The computer-implemented method includes (i) identifying, based upon perception sensor data of a plurality of perception sensors, a plurality of actors in an environment of an autonomous vehicle; (ii) generating a respective anticipated trajectory on a canvas for each actor of the plurality of actors; (iii) generating a plurality of anticipated trajectories of the autonomous vehicle, wherein each anticipated trajectory of the plurality of anticipated trajectories of the autonomous vehicle is generated in a separate canvas; (iv) performing a binary AND operation between each pixel of the canvas having the respective anticipated trajectory for each actor of the plurality of actors and each pixel of a canvas having an anticipated trajectory of the plurality of anticipated trajectories of the autonomous vehicle; (v) based upon the performed binary AND operation, identifying one or more pixels in which the anticipated trajectory of the plurality of anticipated trajectories of the autonomous vehicle having collision with at least one actor of the plurality of actors; and (vi) discarding the anticipated trajectory of the plurality of anticipated trajectories of the autonomous vehicle.

In yet another aspect, an autonomous vehicle including a plurality of perception sensors, at least one memory configured to store machine executable instructions, and at least one processor communicatively coupled with the at least one memory is disclosed. The at least one processor is configured to execute the machine executable instructions to configure the at least one processor to: identify, based upon perception sensor data of a plurality of perception sensors, a plurality of actors in an environment of the autonomous vehicle; generate a respective anticipated trajectory on a canvas for each actor of the plurality of actors; generate a plurality of anticipated trajectories of the autonomous vehicle, wherein each anticipated trajectory of the plurality of anticipated trajectories of the autonomous vehicle is generated in a separate canvas; perform a binary AND operation between each pixel of the canvas having the respective anticipated trajectory for each actor of the plurality of actors and each pixel of a canvas having an anticipated trajectory of the plurality of anticipated trajectories of the autonomous vehicle; based upon the performed binary AND operation, identify one or more pixels in which the anticipated trajectory of the plurality of anticipated trajectories of the autonomous vehicle having collision with at least one actor of the plurality of actors; and discard the anticipated trajectory of the plurality of anticipated trajectories of the autonomous vehicle.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1. is a schematic view of an autonomous truck;

FIG. 2 is a block diagram of the autonomous truck shown in FIG. 1;

FIG. 3 is a block diagram of an example computing system;

FIG. 4 is an example illustration of a candidate trajectory for an autonomous vehicle and a predicted trajectory for another actor on the road;

FIG. 5 is an example plotting of a candidate trajectory corresponding to an autonomous vehicle or any actor in an environment of the autonomous vehicle;

FIG. 6 is an example illustration of a candidate trajectory for the autonomous vehicle and candidate trajectory for two other actors in the environment of the autonomous vehicle;

FIG. 7 is another example illustration of a candidate trajectory for the autonomous vehicle and candidate trajectory for two other actors in the environment of the autonomous vehicle; and

FIG. 8 is a flow-chart of an example method of parallelized occupancy grid collision checking.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing.

Some structural or method features may be shown in specific arrangements and/or orderings in the drawings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments, and, in some embodiments, it may not be included or may be combined with other features.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

One or more of the following terms may be used in the disclosure, and their definition is provided below.

An autonomous vehicle: An autonomous vehicle is a vehicle that is able to operate itself to perform various operations such as controlling or regulating acceleration, braking, steering wheel positioning, and so on, without any human intervention. An autonomous vehicle has an autonomy level of level-4 or level-5 recognized by National Highway Traffic Safety Administration (NHTSA).

A semi-autonomous vehicle: A semi-autonomous vehicle is a vehicle that is able to perform some of the driving related operations such as keeping the vehicle in lane and/or parking the vehicle without human intervention. A semi-autonomous vehicle has an autonomy level of level-1, level-2, or level-3 recognized by NHTSA.

A non-autonomous vehicle: A non-autonomous vehicle is a vehicle that is neither an autonomous vehicle nor a semi-autonomous vehicle. A non-autonomous vehicle has an autonomy level of level-0 recognized by NHTSA.

Mission control: Mission control, as described in the present disclosure, refers to one or more application servers, and one or more database servers communicatively coupled with each other and one or more autonomous vehicles of a fleet. Mission control receives sensor data collected by one or more sensors of the one or more autonomous vehicles of the fleet and transmit data including, but not limited to, trajectory data, described herein, to the one or more autonomous vehicles of the fleet.

State space of an autonomous vehicle: State space of an autonomous vehicle is a representation of the autonomous vehicle's position, velocity, and heading in a three-dimensional (3D) space. State space models are used to estimate the vehicle's position and plan its path.

Candidate trajectory: Within the BMP technologies, a candidate trajectory is defined as a sequence of waypoints over a specified time horizon (typically 12 to 15 seconds) starting from the autonomous vehicle's current location. Each waypoint includes a timestamp and information about the planned pose, curvature, velocity, and acceleration of the autonomous vehicle at that time. Generally, the waypoints are uniformly spaced apart in time. By way of an example, typical spacing in time between two waypoints may be 0.05 seconds.

Autonomous vehicle polygon: An autonomous vehicle polygon may also be referenced herein as a self-driving truck (SDT) polygon. At each waypoint along the candidate trajectory, the autonomous vehicle or SDT is represented by a 2D polygon. The 2D polygon may be the convex hull encompassing the geometry of the SDT or autonomous vehicle. The convex hull is further inflated by a configurable safety margin to ensure the SDT or autonomous vehicle maintains a safety buffer distance from other actors (or objects or vehicles) in the environment of the autonomous vehicle or SDT.

Actors and predicted trajectories: Actors in the present disclosure refer to moving objects in the vicinity of the autonomous vehicle or SDT. For each actor, an actor prediction component estimates a predicted future trajectory. The predicted trajectory includes a sequence of waypoints over a specified time horizon (typically 12 to 15 seconds) starting from the actor's current location. Each waypoint consists of a timestamp and information about the predicted pose and velocity of the actor at that time. The waypoints are uniformly spaced apart in time, for example, 0.05 seconds. Further, at each waypoint along the candidate trajectory, the actor is generally represented by a 2D polygon, as described herein, for an autonomous vehicle polygon.

As described herein, the BMP technologies is a component of a Virtual Driver (VD) stack and generates safe and comfortable trajectories for the autonomous vehicle to follow. The BMP technologies consume information from upstream components associated with perception, actor prediction, and mapping technologies to generate a trajectory information for the autonomous vehicle. Generally, safety and comfort of the planned trajectory are achieved by imposing constraints on the generated trajectory within the BMP component. One category of these constraints is proximity constraints. Proximity constraints ensure that the autonomous vehicle should never be in collision with, or too close to, objects in its environment.

The BMP technologies explore different trajectories in the state space of the autonomous vehicle, and each of the trajectories is evaluated based on the imposed constraints. Based upon the evaluation, a trajectory that has the least constraint violations is selected for the autonomous vehicle. Evaluation of the Proximity constraints is typically achieved by representing the autonomous vehicle and the surrounding objects as polygons in two-dimensional (2D) space and checking if the polygons intersect.

Since the autonomous vehicle and other motor vehicles (semi-autonomous or non-autonomous vehicles) are dynamic in nature, these polygon intersection checks need to be performed at each timestep along the candidate planned trajectory for the autonomous vehicle. Since there are numerous candidates planned trajectories and upwards of a hundred timesteps per trajectory, the polygon intersection checks need to be performed several times. Additionally, the polygon intersection checks need to be extremely efficient to ensure that the BMP technologies adhere to the allowed latency budget.

Various embodiments in the present disclosure are directed to an efficient methodology for checking whether a candidate trajectory violates any of the proximity constraints by performing two-dimensional (2D) polygon intersection checks. In particular, whether a candidate trajectory violates any of the proximity constraints is performed as a sequence of Boolean logical operations on binary image canvases and thereby reducing a computational load and improving speed of the collision checking process.

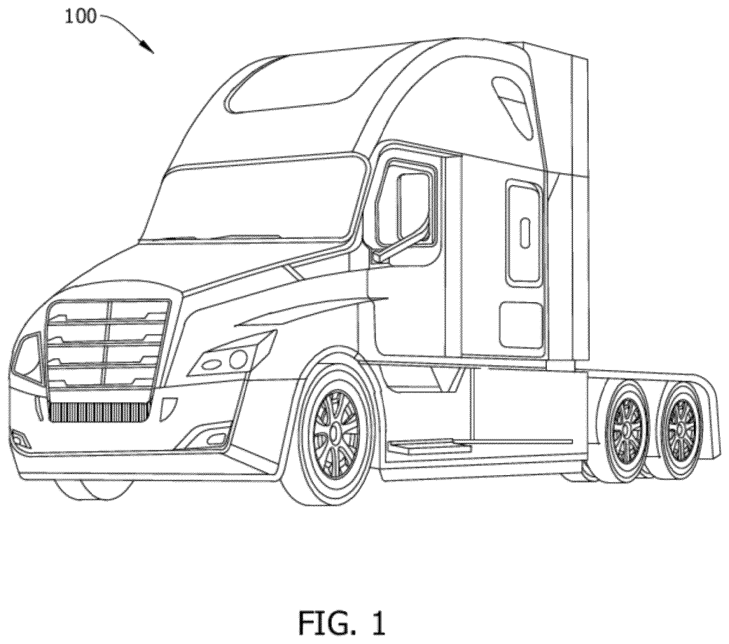

FIG. 1 illustrates a vehicle 100, such as a truck that may be conventionally connected to a single or tandem trailer to transport the trailer (not shown in FIG. 1) to a desired location. The vehicle 100 includes a cabin that can be supported by, and steered in the required direction, by front wheels and rear wheels that are partially shown in FIG. 1. Front wheels are positioned by a steering system that includes a steering wheel and a steering column (not shown in FIG. 1). The steering wheel and the steering column may be located in the interior of cabin.

The vehicle 100 may be an autonomous vehicle, in which case the vehicle 100 may omit the steering wheel and the steering column to steer the vehicle 100. Rather, the vehicle 100 may be operated by an autonomy computing system (not shown in FIG. 1) of the vehicle 100 based on data collected by a sensor network (not shown in FIG. 1) including one or more sensors. The vehicle 100 may be an ego vehicle referenced herein.

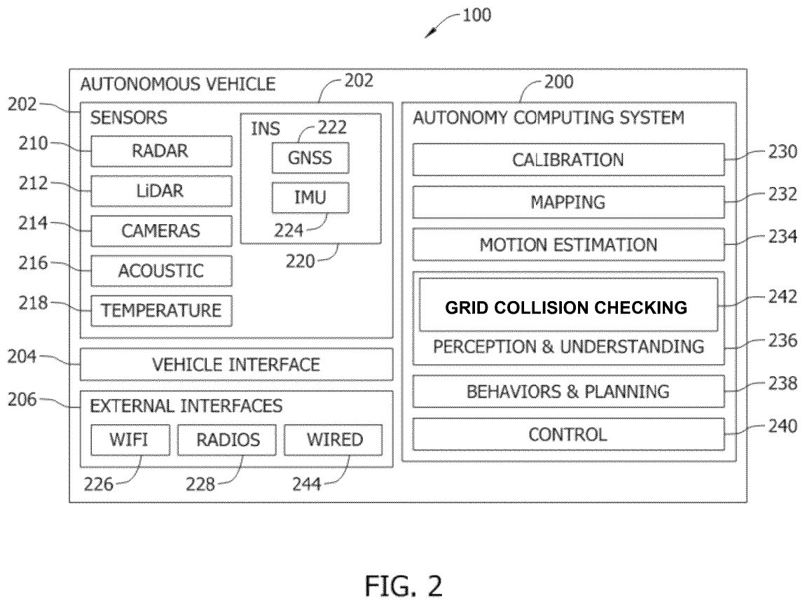

FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, and navigation sensors. Navigation sensors, as described herein, may be one or more inertial navigation system (INS) sensors (or systems) 220, one or more global navigation satellite system (GNSS) sensors 222, or one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 200 to determine how to control operations of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of the multiple cameras 214 may be processed to identify one or more construction markers or other objects in the environment surrounding autonomous vehicle 100. In some embodiments, the image data generated by cameras 214 may be sent to autonomy computing system 200 or other aspects of autonomous vehicle 100 or mission control (a hub) or both.

Cameras 214 may have temperature sensors 218 (e.g., one or more of negative temperature coefficient (NTC) thermistors, resistance temperature detectors (RTDs), thermocouples, or semiconductor-based integrated (IC) sensors) positioned on an external surface, or an internal surface, or both, to measure temperature on a camera lens surface of each of cameras 214. Additionally, temperature sensors 218 may be positioned on other areas of the autonomous vehicle 100, e.g., to measure ambient temperature.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. RADAR sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw RADAR sensor data) from the emitted radio waves. In some embodiments, the system inputs from cameras 214, RADAR sensors 210, or LiDAR sensors 212 may be used in combination to identify one or more construction markers (or nodes) around autonomous vehicle 100.

GNSS receiver 222 is positioned on autonomous vehicle 100 and may be configured to determine a location of autonomous vehicle 100, which it may embody as GNSS data. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment. Additionally, or alternatively, GNSS receiver 222 may be configured to receive RTK and GNSS position information from satellite-based systems.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5G, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically, or manually) via external interfaces 206 or updated on demand. In some embodiments, autonomous vehicle 100 may deploy with all of the data it needs to complete a mission (e.g., perception, localization, and mission planning) and may not utilize a wireless connection or other connections while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and a grid collision checking module 242. The grid collision checking module 242, for example, may be embodied within another module, such as perception and understanding module 236, behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100. The grid collision checking module 242 is configured to efficiently and robustly check whether a candidate trajectory violates any of the proximity constraints by performing a sequence of Boolean logical operations on binary image canvases and thereby reducing a computational load and improving speed of the collision checking process.

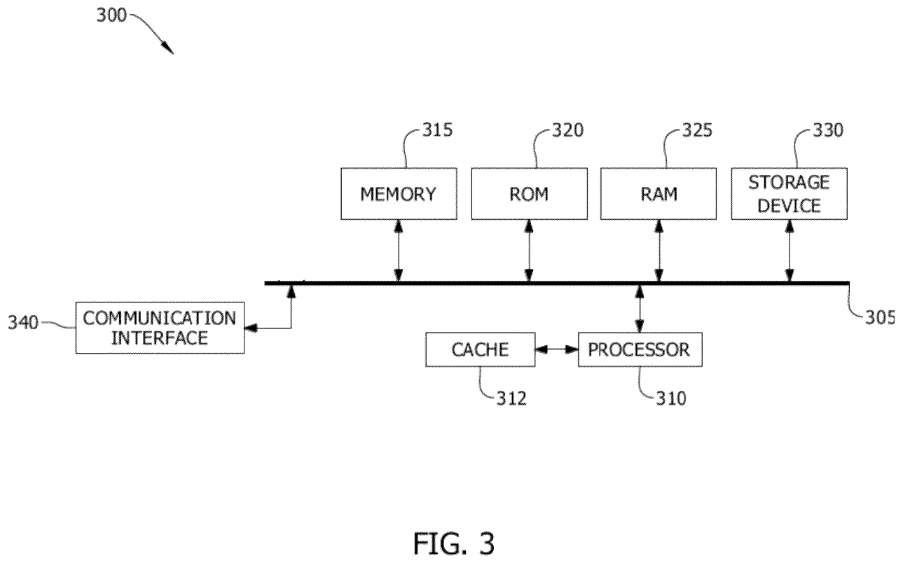

FIG. 3 illustrates an example computing system 300 that can implement various techniques, processes, functions, or methods described herein. Computing system 300 may be embodied within, for example, autonomous vehicle 100 shown in FIG. 1, such as autonomy computing system 200 shown in FIG. 2. The components of computing system 300 are shown in electrical communication with each other using a connection 305, such as a bus. The example computing system 300 includes a processing unit (CPU or processor) 310 and a computing device connection 305 that couples various computing device components, including computing device memory 315, such as a read only memory (ROM) 320 and a random-access memory (RAM) 325, to processor 310.

The processor 310 may be communicatively coupled with a communication interface 340 to communicate with external entities such as, mission control, or one or more other vehicles using V2V communication. Accordingly, the communication interface 340 may include one or more of a radio interface, an electronic sign board mounted on autonomous vehicle 100, a public address system or a loudspeaker positioned at autonomous vehicle 100. The radio interface may be configured for at least one of: (i) a vehicle-to-vehicle communication technique, (ii) citizens band radio frequencies; (iii) a Bluetooth signal; and (iv) a short message service (SMS) technology.

Computing system 300 can include a cache 312 of high-speed memory connected directly with, in close proximity to, or integrated as part of processor 310. Computing system 300 can copy data from memory 315 and/or storage device 330 to cache 312 for quick access by processor 310. In this way, cache 312 can provide a performance boost that avoids processor 310 delays while waiting for data. These and other modules can control or be configured to control processor 310 to perform various actions. Other computing device memory 315 may be available for use as well. Memory 315 can include multiple different types of memory with different performance characteristics. Processor 310 can include any general-purpose processor, central processing unit (CPU), or graphics processing unit (GPU) in combination with a hardware or software provision configured to control processor 310 and stored in storage device 330, as well as any special-purpose processor where software instructions are incorporated into the processor design. Processor 310 may be a self-contained system, containing multiple cores or processors, a bus, memory controller, cache, etc. A multi-core processor may be symmetric or asymmetric.

Storage device 330 is a non-volatile memory and can be one or more of a hard disk or other types of computer readable media that can store data that are accessible by a computer, such as a magnetic cassette, flash memory card, solid state memory device, digital versatile disk, cartridge, RAM 325, ROM 320, or hybrids thereof. Memory 315 or storage device 330 can include software, code, firmware, etc., for controlling processor 310. Other hardware or software modules are contemplated. Memory 315 and storage device 330 are connected to computing device connection 305. In one aspect, a hardware module that performs a particular function can include the software component stored in a computer-readable medium in connection with the necessary hardware components, such as processor 310, computing device connection 305, and so forth, to carry out the function. In the example embodiment, processor 310 may be programmed by encoding an operation or function using one or more executable instructions and providing the executable instructions in memory 315 or storage device 330.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

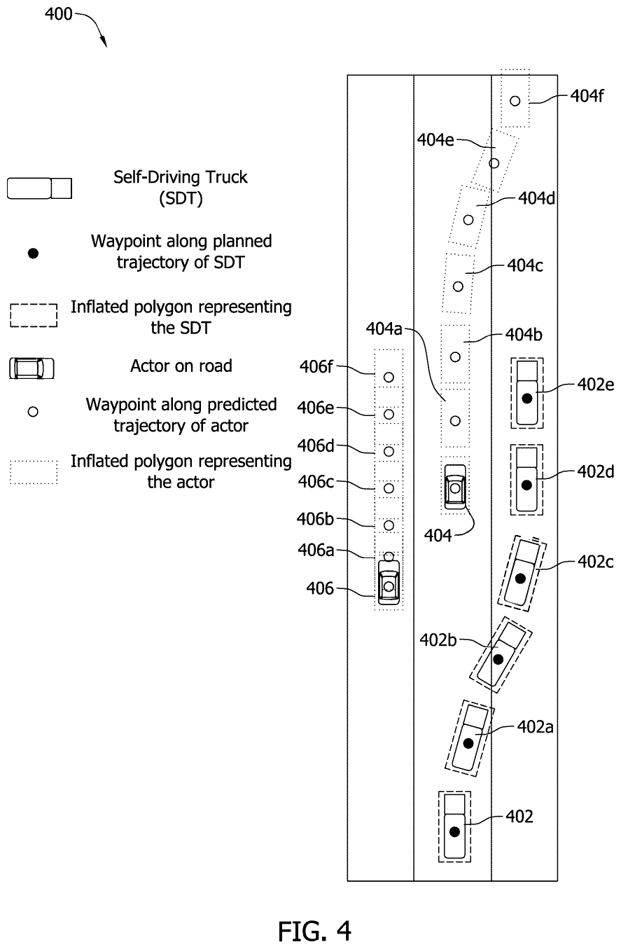

FIG. 4 is an example illustration 400 of a candidate trajectory for an autonomous vehicle (or an SDT) and a predicted trajectory for an actor. The autonomous vehicle and the actor may be displayed as polygons. As shown in FIG. 4, an autonomous vehicle 402 is shown driving on a 3-lane highway 408 along with two other vehicles (or actors) 404 and 406. As shown in FIG. 4, the autonomous vehicle 402 and a vehicle (or an actor) 404 are driving in the middle lane of the 3-lane highway 408, while a vehicle (or an actor) 406 is driving in the left most lane of the 3-lane highway 408. A trajectory for the autonomous vehicle 402 is predicted and shown as 402a through 402e, while a trajectory for the vehicle 404 is predicted and shown as 404a through 404f, and a trajectory for the vehicle 406 is predicted and shown as 406a through 406f. As shown in FIG. 4, each of the autonomous vehicle 402, and the vehicles 404 and 406 may be displayed as inflated polygons. The trajectories of the autonomous vehicle 402, and the vehicles 404 and 406 are shown for a plurality of waypoints along the respective trajectories. As described herein, waypoints of the plurality of waypoints may be uniformly spaced apart in time, for example, at 0.05 seconds.

For a multi-lane highway 408, information of one or more actors 404 and 406 in the environment of the autonomous vehicle 402 may be obtained. As described herein, the information may be in the form of a polygon around each actor and the autonomous vehicle. The information may be based upon perception sensor data of a perception system of the autonomous vehicle and processed using a BMP system of the autonomous vehicle. In some examples, one or more binary canvases, with a pixel resolution of 15 cm*15 cm, are generated. Each of the one or more binary canvases may not have any actor or an autonomous vehicle initially. Each of the one or more binary canvases may display a trajectory corresponding to one of the autonomous vehicle or an actor in the environment of the autonomous vehicle.

The trajectory may be generated and displayed for a predetermined duration such as, 10 seconds, 15 seconds, etc. By way of an example, smaller trajectories may be generated and combined them over time such as for a planning resolution (planning_resolution) of 0.5 seconds and a planning time horizon (planning_time_horizon) of 6 seconds, 12 canvases (planning_time_horizon/planning_resolution) may be generated and combined to get a trajectory result.

An actor map is generated on a canvas in which a plurality of actor polygons is showed. The actor map is used to check collision of the autonomous vehicle with any one of multiple actors in the environment of the autonomous vehicle. An actor corresponding to any one of the autonomous vehicle or other vehicles in the environment of the autonomous vehicle is shown on the actor map using endpoints of the autonomous vehicle or other vehicles in a bird's eye view (BEV). The endpoints in the BEV are translated onto a canvas frame and a polygon is displayed or plotted on the canvas frame. Additionally, possible motion of the autonomous vehicle or other vehicles may also be shown by extending the drawn object trace.

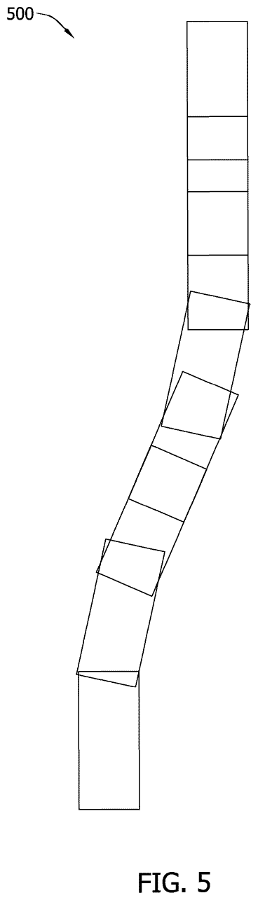

FIG. 5 is an example plotting of a candidate trajectory 500. The candidate trajectory 500 may be a trajectory corresponding to the autonomous vehicle or any actor in the environment of the autonomous vehicle. The candidate trajectory 500 is generated by drawing a polygon along the candidate trajectory at each of plurality of waypoints.

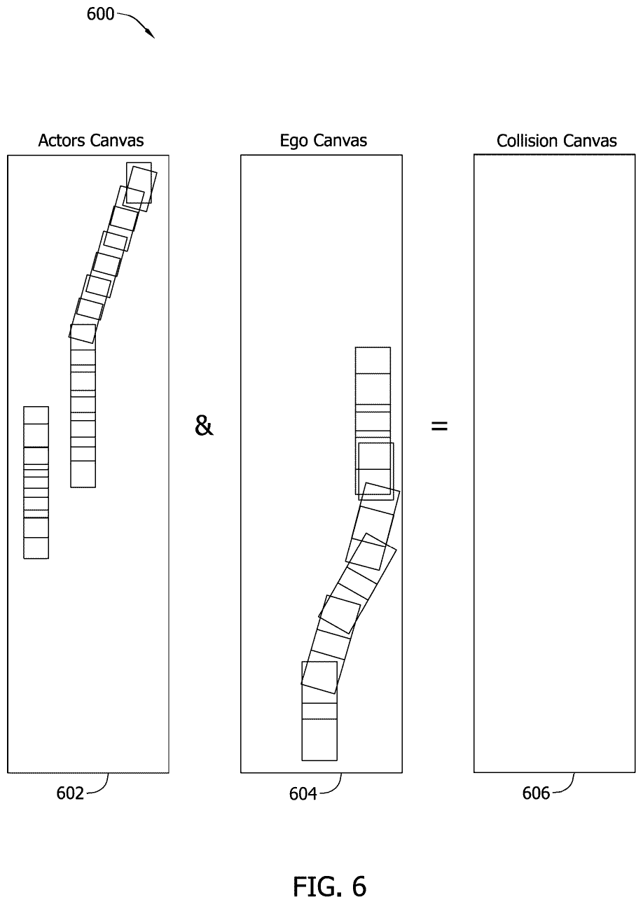

FIG. 6 is an example illustration 600 of a candidate trajectory for the autonomous vehicle and candidate trajectory for two other actors in an environment of the autonomous vehicle. As shown in FIG. 6, a canvas 602 displays candidate trajectories for the two other actors such as 404 and 406 (shown in FIG. 4), and a canvas 604 displays a candidate trajectory for the autonomous vehicle 402 (shown in FIG. 4). The canvas 602 and the canvas 604 may be generated as illustrated herein with reference to FIG. 5.

In order to detect a collision between the autonomous vehicle and any other actors in the environment of the autonomous vehicle, a binary “AND” operation is performed for each pixel of the canvas 602 and each pixel of the canvas 604 and subsequently an elementwise “OR” operation on the canvas to get the collision result. For the example illustration 600, the collision canvas 606 is blank or empty due to the binary “AND” operation performed for each pixel of the canvas 602 with respect to each pixel of the canvas 604 yields no pixel having collision.

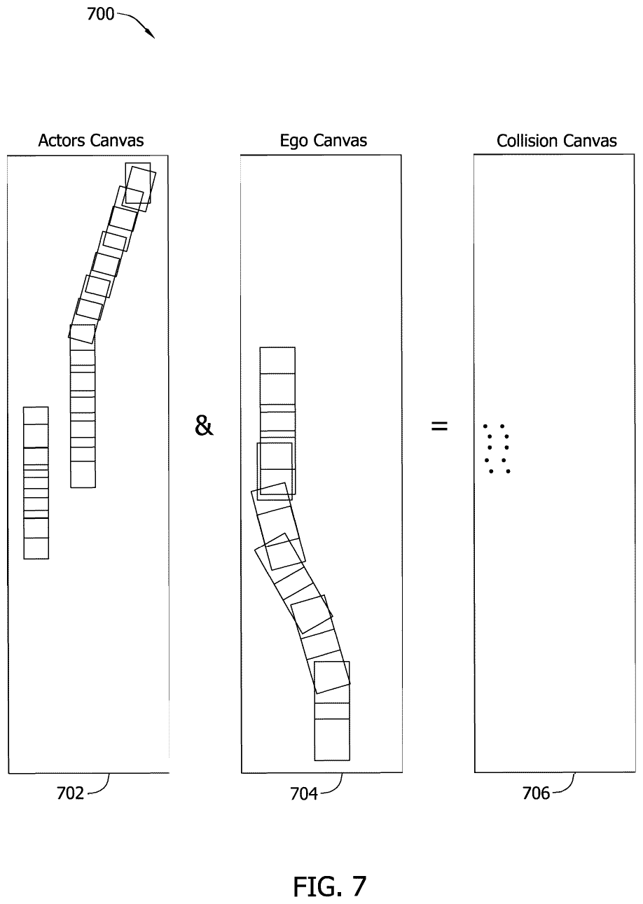

FIG. 7 is another example illustration 700 of a candidate trajectory for the autonomous vehicle and candidate trajectory for two other actors in an environment of the autonomous vehicle. As shown in FIG. 7, a canvas 702 displays candidate trajectories for the two other actors such as 404 and 406 (shown in FIG. 4), and a canvas 704 displays a candidate trajectory for the autonomous vehicle 402 (shown in FIG. 4). The canvas 702 and the canvas 704 may be generated as illustrated herein with reference to FIG. 5.

In order to detect a collision between the autonomous vehicle and any other actors in the environment of the autonomous vehicle, a binary “AND” operation is performed for each pixel of the canvas 702 and each pixel of the canvas 704 and subsequently an elementwise “OR” operation on the canvas to get the collision result. For the example illustration 700, the collision canvas 706 shows collision occurring between the autonomous vehicle 402 and one of the two other actor 404. Accordingly, the assumed trajectory of the autonomous vehicle 402, as shown in FIG. 7, may result in a collision.

Multiple possible trajectories are generated for the autonomous vehicle and each actor in the environment of the autonomous vehicle. Each trajectory of the autonomous vehicle is compared or analyzed with each trajectory of one or more actors in the environment of the autonomous vehicle to identify whether any trajectory of the autonomous vehicle is having collision with any trajectory of the one or more actors in the environment of the autonomous vehicle, and select a trajectory that is not having any collision with any trajectory of any actor in the environment of the autonomous vehicle.

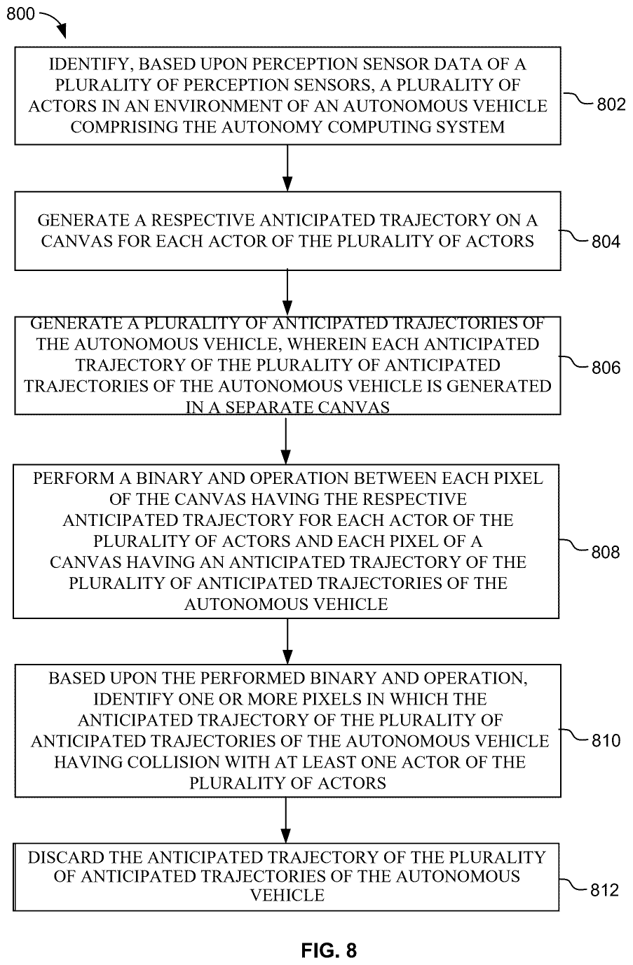

FIG. 8 is a flow-chart of an example method of parallelized occupancy grid collision checking. The method may be performed by an autonomy computing system (shown in FIG. 2) or by a computing system (shown in FIG. 3, which may be an application server). The method includes identifying 802 a plurality of actors in an environment of an autonomous vehicle. The plurality of actors in the environment of the autonomous vehicle is identified based upon perception sensor data of a plurality of perception sensors.

The method includes generating 804 a respective anticipated trajectory on a canvas for each actor of the plurality of actors in the environment of the autonomous vehicle. An anticipated trajectory is a trajectory that an actor may take under many different scenarios. For example, if there are other actors (or vehicles) driving in front of the actor in the same lane, but there are no other actors (or vehicles) in another lane, then the actor may possibly change its current lane and move into the other lane. Further, the autonomous vehicle or an actor of the plurality of actors is displayed as an inflated polygon.

Each of the plurality of anticipated trajectories of the autonomous vehicle, or the respective anticipated trajectory for each actor of the plurality of actors, is generated for a predetermined time duration value. Additionally, each of the plurality of anticipated trajectories of the autonomous vehicle, or the respective anticipated trajectory for each actor of the plurality of actors, includes a plurality of waypoints spaced apart in time by a specific time duration. In some examples, the specific time duration is 0.05 seconds, and the predetermined time duration value is 15 seconds. However, any other suitable value for the specific time duration or the predetermined time duration may be selected.

The method includes generating 806 a plurality of anticipated trajectories of the autonomous vehicle. Each anticipated trajectory of the plurality of anticipated trajectories of the autonomous vehicle is generated in a separate canvas, as described herein.

The method includes performing 808 a binary AND operation between each pixel (or tile) of the canvas having the respective anticipated trajectory for each actor of the plurality of actors and each pixel (or tile) of a canvas having an anticipated trajectory of the plurality of anticipated trajectories of the autonomous vehicle.

The method includes identifying 810 one or more pixels (or tiles) in which the anticipated trajectory of the plurality of anticipated trajectories of the autonomous vehicle having collision with at least one actor of the plurality of actors. The one or more pixels (or tiles) in which the anticipated trajectory of the plurality of anticipated trajectories of the autonomous vehicle having collision is identified based upon the performed 808 binary AND operation.

The method includes discarding 812 the anticipated trajectory of the plurality of anticipated trajectories of the autonomous vehicle. In other words, if the anticipated trajectory is going to have a collision with at least one actor of the plurality of actors in the environment of the autonomous vehicle, then the particular anticipated trajectory is marked as a likely “not safe” trajectory, and such particular anticipated trajectory would be ignored by the autonomous vehicle.

Based upon the performed 808 binary AND operation, one or more pixels (or tiles) in which the anticipated trajectory of the plurality of anticipated trajectories of the autonomous vehicle is not having collision with any actor of the plurality of actors are identified, and selecting the anticipated trajectory of the plurality of anticipated trajectories of the autonomous vehicle for moving forward.

The canvas shown in any of FIG. 4, FIG. 5, FIG. 6, and FIG. 7 may be in a binary format that can be considered as a two-dimensional (2D) array of Booleans. However, for processing by a graphics processing unit (GPU), the 2D array of Booleans is stored as one-dimensional (1D) array to make the computation faster. Further, formulation of the collision checking as a sequence of simple Boolean logical operations on binary image canvases is not computationally intensive in comparison with conventional collision checking approaches that are computationally intensive and require multiple polygon intersection checks. Additionally, formulation of the collision checking as a sequence of simple Boolean logical operations performed using a GPU enhances operational speed of the collision checking process.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a program, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code being understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random-access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

Although certain embodiments have been illustrated and described herein for purposes of description, a wide variety of alternate and/or equivalent embodiments or implementations calculated to achieve the same purposes may be substituted for the embodiments shown and described without departing from the scope of the present disclosure. This application is intended to cover any adaptations or variations of the embodiments discussed herein, including the implementation or utilization of components of the systems or steps independently and separately from other described components or steps. Therefore, it is manifestly intended that embodiments described herein be limited only by the claims.

What is claimed is:

1. An autonomy computing system comprising:
at least one memory configured to store machine executable instructions; and
at least one processor coupled to the at least one memory and configured to execute the machine executable instructions to configure the at least one processor to:
identify, based upon perception sensor data of a plurality of perception sensors, a plurality of actors in an environment of an autonomous vehicle comprising the autonomy computing system;
generate a respective anticipated trajectory on a canvas for each actor of the plurality of actors;
generate a plurality of anticipated trajectories of the autonomous vehicle, wherein each anticipated trajectory of the plurality of anticipated trajectories of the autonomous vehicle is generated in a separate canvas;
perform a binary AND operation between each pixel of the canvas having the respective anticipated trajectory for each actor of the plurality of actors and each pixel of a canvas having an anticipated trajectory of the plurality of anticipated trajectories of the autonomous vehicle;
based upon the performed binary AND operation, identify one or more pixels in which the anticipated trajectory of the plurality of anticipated trajectories of the autonomous vehicle having collision with at least one actor of the plurality of actors; and
discard the anticipated trajectory of the plurality of anticipated trajectories of the autonomous vehicle.

2. The autonomy computing system of claim 1, wherein the at least one processor is further configured to execute the machine executable instructions to configure the at least one processor to display the autonomous vehicle or an actor of the plurality of actors as an inflated polygon.

3. The autonomy computing system of claim 1, wherein each of the plurality of anticipated trajectories of the autonomous vehicle, or the respective anticipated trajectory for each actor of the plurality of actors, is generated for a predetermined time duration value.

4. The autonomy computing system of claim 3, wherein each of the plurality of anticipated trajectories of the autonomous vehicle, or the respective anticipated trajectory for each actor of the plurality of actors, includes a plurality of waypoints spaced apart in time by a specific time duration.

5. The autonomy computing system of claim 4, wherein the specific time duration is 0.05 seconds.

6. The autonomy computing system of claim 3, wherein the predetermined time duration value is 15 seconds.

7. The autonomy computing system of claim 1, wherein the at least one processor is further configured to execute the machine executable instructions to configure the at least one processor to:
based upon the performed binary AND operation, identify one or more pixels in which the anticipated trajectory of the plurality of anticipated trajectories of the autonomous vehicle is not having collision with any actor of the plurality of actors; and
select the anticipated trajectory of the plurality of anticipated trajectories of the autonomous vehicle for moving forward.

8. A computer-implemented method comprising:
identifying, based upon perception sensor data of a plurality of perception sensors, a plurality of actors in an environment of an autonomous vehicle;
generating a respective anticipated trajectory on a canvas for each actor of the plurality of actors;
generating a plurality of anticipated trajectories of the autonomous vehicle, wherein each anticipated trajectory of the plurality of anticipated trajectories of the autonomous vehicle is generated in a separate canvas;
performing a binary AND operation between each pixel of the canvas having the respective anticipated trajectory for each actor of the plurality of actors and each pixel of a canvas having an anticipated trajectory of the plurality of anticipated trajectories of the autonomous vehicle;
based upon the performed binary AND operation, identifying one or more pixels in which the anticipated trajectory of the plurality of anticipated trajectories of the autonomous vehicle having collision with at least one actor of the plurality of actors; and
discarding the anticipated trajectory of the plurality of anticipated trajectories of the autonomous vehicle.

9. The computer-implemented method of claim 8, further comprising displaying the autonomous vehicle or an actor of the plurality of actors as an inflated polygon.

10. The computer-implemented method of claim 8, further comprising generating each of the plurality of anticipated trajectories of the autonomous vehicle, or the respective anticipated trajectory for each actor of the plurality of actors, for a predetermined time duration value.

11. The computer-implemented method of claim 10, wherein each of the plurality of anticipated trajectories of the autonomous vehicle, or the respective anticipated trajectory for each actor of the plurality of actors, includes a plurality of waypoints spaced apart in time by a specific time duration.

12. The computer-implemented method of claim 11, wherein the specific time duration is 0.05 seconds.

13. The computer-implemented method of claim 10, wherein the predetermined time duration value is 15 seconds.

14. The computer-implemented method of claim 8, further comprising:
based upon the performed binary AND operation, identifying one or more pixels in which the anticipated trajectory of the plurality of anticipated trajectories of the autonomous vehicle is not having collision with any actor of the plurality of actors; and
selecting the anticipated trajectory of the plurality of anticipated trajectories of the autonomous vehicle for moving forward.

15. An autonomous vehicle comprising:
a plurality of perception sensors;
at least one memory configured to store machine executable instructions; and
at least one processor coupled to the at least one memory and configured to execute the machine executable instructions to configure the at least one processor to:
identify, based upon perception sensor data of the plurality of perception sensors, a plurality of actors in an environment of the autonomous vehicle;
generate a respective anticipated trajectory on a canvas for each actor of the plurality of actors;
generate a plurality of anticipated trajectories of the autonomous vehicle, wherein each anticipated trajectory of the plurality of anticipated trajectories of the autonomous vehicle is generated in a separate canvas;
perform a binary AND operation between each pixel of the canvas having the respective anticipated trajectory for each actor of the plurality of actors and each pixel of a canvas having an anticipated trajectory of the plurality of anticipated trajectories of the autonomous vehicle;
based upon the performed binary AND operation, identify one or more pixels in which the anticipated trajectory of the plurality of anticipated trajectories of the autonomous vehicle having collision with at least one actor of the plurality of actors; and
discard the anticipated trajectory of the plurality of anticipated trajectories of the autonomous vehicle.

16. The autonomous vehicle of claim 15, wherein the at least one processor is further configured to execute the machine executable instructions to configure the at least one processor to display the autonomous vehicle or an actor of the plurality of actors as an inflated polygon.

17. The autonomous vehicle of claim 15, wherein each of the plurality of anticipated trajectories of the autonomous vehicle, or the respective anticipated trajectory for each actor of the plurality of actors, is generated for a predetermined time duration value.

18. The autonomous vehicle of claim 17, wherein each of the plurality of anticipated trajectories of the autonomous vehicle, or the respective anticipated trajectory for each actor of the plurality of actors, includes a plurality of waypoints spaced apart in time by a specific time duration, wherein the specific time duration is 0.05 seconds.

19. The autonomous vehicle of claim 17, wherein the predetermined time duration value is 15 seconds.

20. The autonomous vehicle of claim 15, wherein the at least one processor is further configured to execute the machine executable instructions to configure the at least one processor to:
based upon the performed binary AND operation, identify one or more pixels in which the anticipated trajectory of the plurality of anticipated trajectories of the autonomous vehicle is not having collision with any actor of the plurality of actors; and
select the anticipated trajectory of the plurality of anticipated trajectories of the autonomous vehicle for moving forward.
